(19) United States
(12) Patent Application Publication
(10) Pub. No.: US 2008/0205688 A1
(43) Pub. Date: Aug. 28, 2008

(54) Speaker

(76) Inventor: Eiji Sato, Fukuroi-Shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/071,556

(22) Filed: Feb. 22, 2008

(30) Foreign Application Priority Data
Feb. 28, 2007 (JP) 2007-48822

(51) Int. Cl. H04R 9/06

(52) U.S. Cl. 381/400

(57) ABSTRACT

A speaker includes: a magnetic circuit; a voice coil bobbin; a voice coil; a diaphragm; a frame to which the outer circumference of the diaphragm is connected via a suspension; and a spider to support the center area of the diaphragm. A magnet unit, a pole piece, a pole piece, and a yoke are included in the magnetic circuit. The yoke has a ring shape with a center opening, and is disposed at the rear of the magnet unit. The magnet unit has a ring structure having a plurality of empty portions arranged equiangularly, and the spider includes a main body and a plurality of legs extending radially outwardly from the main body and is disposed inside the magnetic circuit such that distal end tips of the legs pass beyond the inner diameter of the ring structure of the magnet unit.

### BACKGROUND OF THE INVENTION

1. Field of the Invention

The present invention relates to a speaker for use in miscellaneous audio equipment.

2. Related Art

A speaker is extensively used not only in home or car audio equipment but also in miscellaneous electronic equipment such as a personal computer, a mobile phone, a game instrument, a thin screen TV, and the like. A speaker used in such a piece of equipment, even if small and thin in size, is demanded to provide an excellent sound quality and to have a large input capacity.

FIG. 14 shows a conventional speaker. Referring to FIG. 14, a speaker 100 generally includes: a magnetic circuit 104 composed such that a magnet 101 is sandwiched between a pole piece 102 and a yoke 103 formed in a pot shape wherein a magnetic gap 105 is formed; a frame 106 having its inner circumference connected to the outer circumference of the yoke 103; a surround 107 having its outer edge connected to the front circumferential face of the frame 106; a diaphragm 108 having its circumference connected to the inner edge of the surround 107; a voice coil 109; a bobbin 110 having the voice coil 109 wound therearound and connected to the diaphragm 108; and a spider 111 to suspend the bobbin 110 in the magnetic gap 105. The speaker 100 further includes a gasket 112, tinsel wires 103 leading out from the voice coil 109, and a terminal plate 114 having the tinsel wires 103 connected thereto.

In order to successfully achieve a lower profile, the speaker 100 has to be designed in consideration of the vibration amplitude of the component members. In the speaker 100, however, there is a problem that when the voice coil 109 vibrates with a large amount of amplitude, the spider 111 gets in touch with the pot yoke 103 of the magnetic circuit 104 thereby generating noises.

In order to overcome the problem described above, a low profile speaker is proposed which incorporates a spider attaching structure adapted to prevent generation of noises even when a voice coil vibrates with a large amount of amplitude.

For example, Japanese Patent Application Laid-Open No. H9-238396 discloses a speaker which achieves a lower profile while achieving a large enough amplitude, generates no noises of rolling, and enables reproduction with a large sound pressure. In the speaker, a spider is disposed at an area inside of a magnetic gap of a magnetic field system, a space for vibration of the spider is provided below the spider, and a vibration system is suspended such that parts of the vibration system excluding a voice coil bobbin vertically disposed in the magnetic gap are attached to the movable end of the spider, thus the voice coil bobbin is not attached to the spider to suspend the vibration system.

Also, Japanese Patent Application Laid-Open No. 2003-339099 discloses a speaker in which, while a lower profile is realized, a spider is prohibited from touching a yoke even when a voice coil vibrates with a large amplitude thus generating no noises. In the speaker, the yoke has at least one through-hole, and the spider has its one end connected to a frame and has the other end passing through the through-hole so as to suspend the bottom portion of a voice coil bobbin.

The speakers described above, however, have the following disadvantages.

In the speaker disclosed by the aforementioned Japanese Patent Application Laid-Open No. H9-238396, since it is not possible to set the outer diameter of the spider to be larger than the inner diameter of the voice coil bobbin, the stiffness of the spider cannot be adequately reduced thus failing to lower its lowest resonance frequency (hereinafter referred to simply as “resonance frequency” as appropriate), that is to say that the sound pressure level cannot be increased in the bass range.

In the speaker disclosed by the aforementioned Japanese Patent Application Laid-Open No. 2003-339099, when the diameter of the speaker is small while the diameter of the voice coil bobbin is relatively large, the difference between the outer and inner diameters of the spider is forced to be small, and therefore, like the speaker of the patent document No. H9-238396, the stiffness of the spider cannot be adequately reduced thus failing to lower its resonance frequency, that is to say, the sound pressure level cannot be increased in the bass range.

### SUMMARY OF THE INVENTION

The present invention has been made in light of the above problems, and it is an object of the present invention to provide a speaker in which, while achieving a lower profile, a vibration system is free from the rolling phenomenon and noise generation even when a large input is applied, and a wide reproduction frequency range can be achieved by setting the resonance frequency to be low.

According to an aspect of the present invention, there is provided a speaker comprising:

a magnetic circuit having a ring shape and including: a magnet unit which has a ring structure having a plurality of empty portions arranged equiangularly; a pole piece; and a yoke which has a ring shape with a center opening and is disposed at a rear of the magnet unit;

a voice coil bobbin;

a voice coil wound around the voice coil bobbin, suspended in a gap of the magnetic circuit, and having lead-out wires led out therefrom;

a diaphragm to move back and forth together with the voice coil;

a frame to which an outer circumference of the diaphragm is connected via a suspension; and

a spider to support a center area of the diaphragm, wherein the spider has a main body and a plurality of legs extending radially outwardly from the main body, and distal end tips of the legs pass beyond an inner diameter of the ring structure of the magnet unit.

According to an aspect of the present invention, there is provided a speaker comprising:

a magnetic circuit of an outer magnet type, the magnetic circuit having a ring shape and including: a magnet unit; a pole piece; a yoke which has a ring shape with a center opening, is disposed at a rear of the magnet unit, and has the pole piece integrally connected thereto; a repulsion magnet unit disposed at a rear of the yoke and having a ring structure having a plurality of empty portions arranged equiangularly; a top plate disposed at a front of the magnet unit, wherein a magnetic gap of the magnetic circuit is formed between an inner circumferential face of the top plate and an outer circumferential face of the pole piece; and a yoke cover disposed at a rear of the repulsion magnet unit;

a voice coil bobbin;

a voice coil wound around the voice coil bobbin, suspended in the gap of the magnetic circuit, and having lead-out wires led out therefrom;

a diaphragm to move back and forth together with the voice coil;

a frame to which an outer circumference of the diaphragm is connected via a suspension; and

a spider to support a center area of the diaphragm, wherein the spider has a main body and a plurality of legs extending radially outwardly from the main body, and distal end tips of the legs of the spider pass beyond an inner diameter of the ring structure of the repulsion magnet unit.

The speaker structured as describe above, while achieving reduction in thickness and weight, is free from generation of noises due to, for example, the rolling phenomenon of the vibration system even when a large output is applied, and can set resonance frequency to be low thereby extending a frequency band for sound reproduction.

### BRIEF DESCRIPTION OF THE DRAWINGS

FIG. 1A is a top plan view of a speaker according to a first embodiment of the present invention;

FIG. 1B is a cross sectional view of the speaker of FIG. 1A, taken along a line A-O-B;

FIG. 1C is a top plan view of a magnetic circuit of the speaker of FIG. 1A, omitting a pole piece;

FIG. 1D is a top plan view of a spider of the speaker of FIG. 1A;

FIG. 2 is a cross sectional view of a speaker according to a second embodiment of the present invention;

FIG. 3 is a cross sectional view of a speaker according to a third embodiment of the present invention;

FIG. 4 is an explanatory cross sectional view of the speaker of FIG. 3, wherein a diameter of a voice coil (bobbin) is to be reduced as one example;

FIG. 5 is an explanatory view of a dimensional variation of an outer diaphragm in association with a dimensional/configurational change of a surround in the speaker of FIG. 3;

FIG. 6A is a cross sectional view of a speaker according to a fourth embodiment of the present invention;

FIG. 6B is a cross sectional view of a speaker according to a variation of the four embodiment of the present invention;

FIG. 7A is a cross sectional view of a speaker according to a fifth embodiment of the present invention;

FIG. 7B is a cross sectional view of a speaker according to a variation of the fifth embodiment of the present invention;

FIG. 8 is a cross sectional view of a speaker according to a sixth embodiment of the present invention;

FIG. 9A is a cross sectional view of a speaker according to a seventh embodiment of the present invention;

FIG. 9B is a perspective view of a magnet unit of the speaker of FIG. 9A;

FIG. 10A is a cross sectional view of a speaker according to an eighth embodiment of the present invention;

FIG. 10B is a perspective view of a magnet unit of the speaker of FIG. 10A;

FIG. 11A is a top plan view of a speaker according to a ninth embodiment of the present invention;

FIG. 11B is a cross sectional view of the speaker of FIG. 11A, taken along a line A-O-B;

FIG. 11C is a top plan view of a magnetic circuit of the speaker of FIG. 11A, omitting a pole piece;

FIG. 12 is a cross sectional view of a speaker according to a tenth embodiment of the present invention;

FIG. 13 is a top plan view of a alternative example of a spider applicable to the present invention; and

FIG. 14 is a cross sectional view of a conventional speaker.

### DETAILED DESCRIPTION OF THE INVENTION

Embodiments according to the present invention will now be explained with reference to the accompanying drawings.

Exemplary embodiments of the present invention will hereinafter be described with reference to the accompanying drawings.

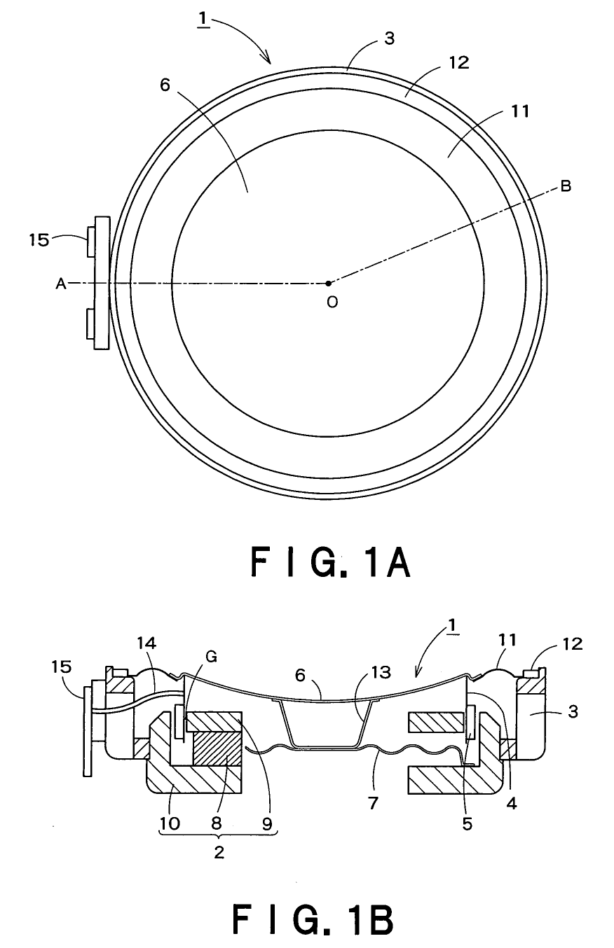

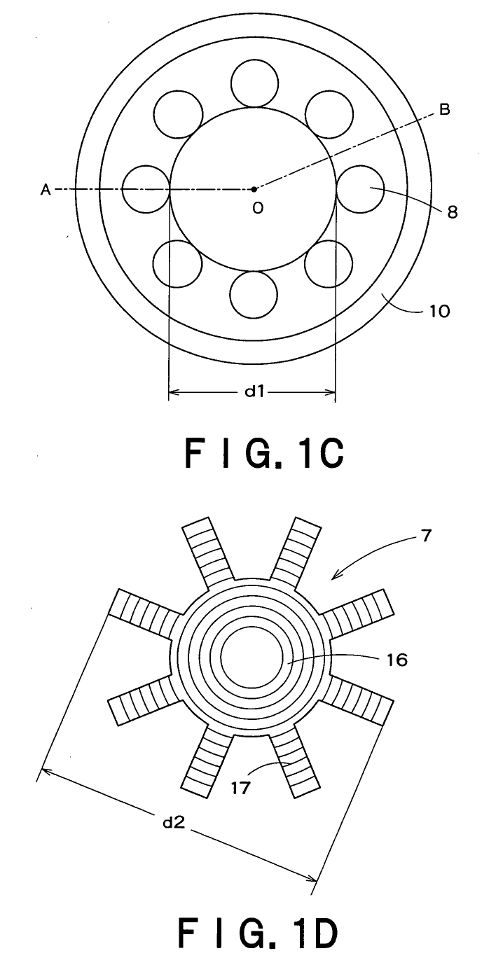

A first embodiment of the present invention will be described with reference to FIGS. 1A, 1B and 1C. Referring to FIGS. 1A and 1B, a speaker 1 according to the first embodiment generally includes: a magnetic circuit 2 having a ring shape; a frame 3; a voice coil bobbin 4 (hereinafter referred to simply as “bobbin” as appropriate); a voice coil 5 wound around the bobbin 4; a diaphragm 6 having an inverted dome shape; and a spider 7.

Referring further to FIG. 1C, the magnetic circuit 2 includes a magnet unit made up of a plurality (eight in FIG. 1C) of magnet pieces 8 so as to form a ring structure with an inner diameter d1, a pole piece 9 disposed at the front of the magnet unit (magnet pieces 8), and a yoke 10 shaped like a pot, positioned at the rear of the magnet unit and radiating outwardly, wherein both the pole piece 9 and the yoke 10 have a ring shape, and the yoke 10 has its outer circumference connected to the frame 3. A magnetic gap G is formed between the outer circumferential face of the pole piece 9 and the inner circumferential face of the yoke 10, and the voice coil 5 is disposed in the magnetic gap G so as to be movable back and forth.

The outer circumference of the diaphragm 6 is connected to the frame 3 via a surround 11, and a gasket 12 is attached to the outer edge of the surround 11. The rear of the outer circumference of the diaphragm 6 is connected to the bobbin 4, and the rear of the center area of the diaphragm 6 is connected to the front of the center area of the spider 7 via a coupler 13.

The speaker 1 further includes tinsel wires 14 which have their one ends connected to lead-out wires (not shown) led out from the voice coil 5, pass between the diaphragm 6/the surround 11 and the yoke 10 of the magnetic circuit 2 and through the frame 3, and which have the other ends connected to a terminal plate 15 disposed at the side of the frame 3, or alternatively at the outer circumference of the yoke 10 though not shown.

The plurality of magnet pieces 8 each have a circular cylinder shape and are arranged equiangularly along a circular line inside the circumference of the yoke 10 as shown in FIG. 1C. Referring to FIG. 1D, the spider 7 is composed of a central body 16 having a circular shape and a plurality (eight in the figure) of legs 17 integrally extending radially outwardly from the outer circumference of the central body 16, and a circular line passing the distal end tips of the legs 17 defines a circle having a diameter (diametrical dimension) d2. The legs 17 each go in an empty space between two adjacent magnet pieces 8 and have their distal end tips attached to the front of the bottom portion of the yoke 10, thus the diametrical dimension d2 is greater than the inner diameter d1 of the ring structure of the magnet unit.

In the speaker 1 structured as described above, since the spider 7 is lodged inside of the magnetic circuit 2, the distance between the diaphragm 6 and the pole piece 9 can be reduced compared to a conventional speaker in which a spider is disposed between a diaphragm and a magnetic circuit, thus achieving a low-profile speaker. Also, even if the bobbin 4 has a large diameter when the speaker 1 has a limited diameter, the spider 7 can be provided with effective functions, and therefore the speaker 1 is less likely to suffer the rolling phenomenon of a vibration system than the conventional speaker when a large input is applied, thus the bobbin 4 and the voice coil 5 or its lead-out wires are prevented from touching the magnetic circuit 2. Consequently, the speaker 1 can have an increased input resistance (higher rating), and at the same time the magnetic gap G does not have to be increased thus preventing a decrease in sound pressure attributable to lowering of magnetic flux density.

Further, since the diametrical dimension d2 of the spider 7 can be set greater than the outer diameter of the bobbin 4, the stiffness of the spider 7 can be easily reduced, and so the resonance frequency can be lowered, which enables expansion of sound reproduction frequency range.

Accordingly, in the speaker 1 according to the first embodiment, reduction can be achieved in speaker size and profile, the rolling phenomenon of the vibration system or noises are prevented when a large input is applied, and the resonance frequency can be lowered thus enabling an increase in the sound reproduction frequency band.

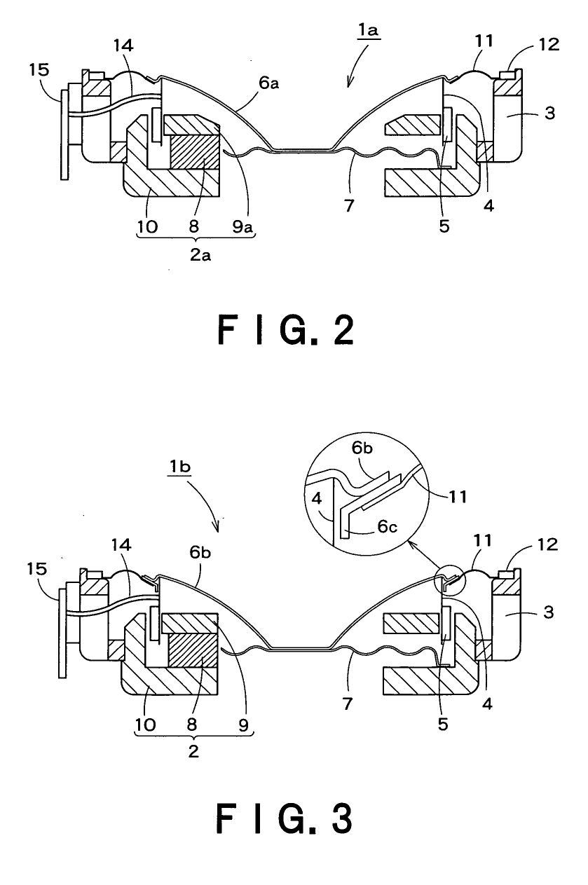

A second embodiment of the present invention will be described with reference to FIG. 2. Referring to FIG. 2, a speaker la according to the second embodiment is structured essentially the same as the speaker 1 according to the first embodiment with distinct differences residing in diaphragm shape and connection structure between a diaphragm and a spider. In explaining the example of FIG. 2, any component parts corresponding to those in FIG. 1B are denoted by the same reference numerals, and a detailed description thereof will be omitted below with focus put on the differences.

The speaker 1a of FIG. 2 includes a diaphragm 6a which is formed in a truncated circular cone shape, rather than an inverted dome shape. The diaphragm 6a thus shaped is connected to a spider 7 such that the rear of the center area (truncated portion) of the diaphragm 6a is attached directly to the front of the center area of the spider 7 without using any connecting member like the coupler 13 incorporated in the above-described speaker 1 of the first embodiment.

Also, a magnetic circuit 2a included in the speaker 1a differs from the magnetic circuit 2 of the speaker 1 of the first embodiment in that a pole piece 9a, is formed in a ring shape like the pole piece 9 of the first embodiment, and has its front inner circumferential edge chamfered thereby increasing the slanted area of the diaphragm 6a as much as possible. The structure of the pole piece 9a is advantageous in successfully achieving a lower profile. The front inner circumferential edge of the pole piece 9a may be kept unchamfered, if chamfering is not definitely required.

The speaker 1a described above provides the same effects and advantages as the speaker 1 of the first embodiment, and furthermore, due to non-use of a connecting member (coupler), can reduce the number of components compared to the speaker 1.

A third embodiment of the present invention will be described with reference to FIG. 3. The third embodiment can be regarded as a variation of the second embodiment of FIG. 2, and in explaining the example of FIG. 3, any component parts corresponding to those in FIG. 2 are denoted by the same reference numerals. Referring to FIG. 3, a speaker 1b according to the third embodiment has almost the same structure as the speaker 1a of FIG. 2 according to the second embodiment with only difference found in diaphragm composition, and description will be focused on the difference.

The speaker 1b of FIG. 3 differs from the speaker 1a of FIG. 2 in that a diaphragm has a central diaphragm 6b and an outer diaphragm 6c. The central diaphragm 6b is substantially the same as the diaphragm 6a of FIG. 2. The outer diaphragm 6c is located outside a bobbin 4, the front of the outer diaphragm 6c is attached to the rear of the outer circumference of the central diaphragm 6b, and the rear of the outward side of the outer diaphragm 6c is attached to the front of the inner edge of a surround 11. Thus, the central diaphragm 6b, the outer diaphragm 6c, and the surround 11 in combination make up a part of its vibration system. The rear of the center area of the central diaphragm 6b is connected to the front of the center area of a spider 7. In this connection, in FIG. 3, the speaker 1b includes a magnetic circuit 2 which is the same as that of the speaker 1 according to the first embodiment, that is to say, the front inner circumferential edge of a pole piece 9 included in the magnetic circuit 2 is unchamfered, but the present invention is not limited to this structure and may incorporate a chamfered pole piece like the pole piece 9a of the magnetic circuit 2a of the second embodiment where necessary.

With a part of the vibration system having the central diaphragm 6b, the outer diaphragm 6c and the surround 11 as described above, the outer diameter of the central diaphragm 6b and the inner diameter of the outer diaphragm 6c can be varied according to the change of the diameter of the voice coil 5 (the bobbin 4), whereby various sound characteristics can be flexibly achieved.

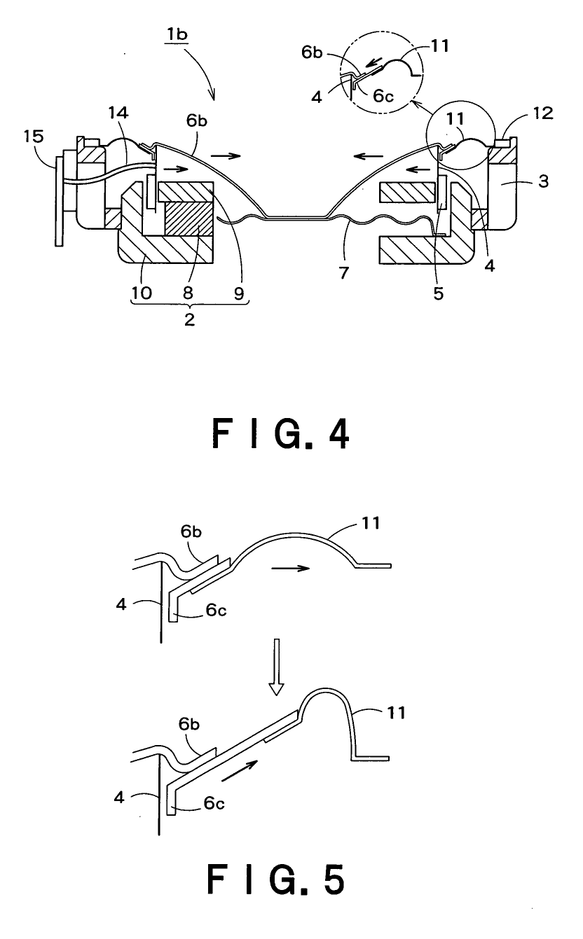

For example, referring to FIG. 4, when the diameter of the bobbin 4 is decreased, the outer diameter of the central diaphragm 6b is also decreased, and the inner diameter of the outer diaphragm 6c is decreased accordingly such that the inner circumference of the outer diaphragm 6c is located closer to the center, which is enlargedly and demonstrably shown in a circled drawing at the upper right in FIG. 4. And, when the diameter of the bobbin 4 is increased, the inner circumference of the outer diaphragm 6c is located farther from the center.

The speaker 1b has its output sound pressure frequency characteristic composed of a sound pressure characteristic outputted from the central diaphragm 6b and a sound pressure characteristic outputted from the outer diaphragm 6c. When the diameter of the bobbin 4 is changed, the dimensions of the central diaphragms 6b and the outer diaphragm 6c are varied, and the sound pressure characteristic is caused to vary accordingly. Thus, a predetermined output pressure sound frequency characteristic can be achieved by appropriately determining the diameter of the bobbin 4, and a variety of sound characteristics are readily available.

In this connection, the dimension of the outer diaphragm 6c can be varied without necessarily changing the dimensions of the bobbin 4 and/or central diaphragm 6b. For example, if the size or shape of the surround 11 is changed so that its inner diameter (inner edge) is changed, the outer diameter of the outer diaphragm 6c can be varied. FIG. 5 shows an example where the surround 11 is deformed so as to decrease its inner diameter, whereby the outer diameter of the outer diaphragm 6c can be increased accordingly.

The speaker 1b structured as described above can provide the same effects and advantages as the speakers 1 and la according respectively to the first and second embodiments, and further can achieve a variety of sound characteristics.

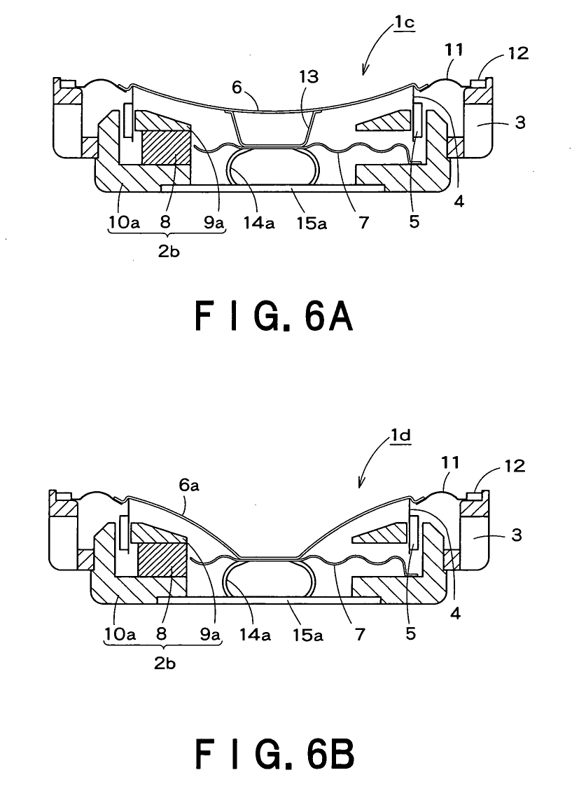

A fourth embodiment of the present invention will be described with reference to FIGS. 6A and 6B showing respective variations. Referring to FIGS. 6A and 6B, speakers 1c and 1d according to the respective variations of the fourth embodiment are structured substantially the same respectively as the speakers 1 and 1a according to the first and second embodiments except the disposition of tinsel wires and a terminal plate. In explaining the examples of FIGS. 6A and 6B, any component parts corresponding to those in FIGS. 1B and 2 are denoted by the same reference numerals, and description will be made mainly on the differences from the speakers 1 and 1a.

Referring to FIG. 6A, in the speaker 1c, lead-out wires (not shown) led out from a voice coil 5 are routed on the rear of a diaphragm 6 and along a coupler 13 so as to reach a spider 7, and tinsel wires 14a have their one ends connected to the lead-out wires (not shown) at the spider 7 and have the other ends connected to a terminal plate 15a attached at the bottom face of the center area of a yoke 10a shaped like a pot. Thus, the tinsel wires 14a are disposed inside of a magnetic circuit 2b.

Referring now to FIG. 6B, in the speaker 1d, lead-out wires (not shown) from a voice coil 5 are routed on the rear of a diaphragm 6a so as to reach a spider 7, and tinsel wires 14a have their one ends connected to the lead-out wires (not shown) at the spider 7 and have the other ends connected to a terminal plate 15a attached at the bottom face of the center area of a yoke 10a. Thus, the tinsel wires 14a are disposed inside of a magnetic circuit 2b.

In the speaker 1c/1d of FIG. 6A/6B, the tinsel wires 14a are lodged inside the magnetic circuit 2b having a ring shape, rather than in the space defined between the surround 11/the diaphragm 6/6a and the magnetic circuit 2/2a as in the speaker 1/1a of FIG. 1B/2. Accordingly, in the speaker 1c/1d, the distance between the surround 11/the diaphragm 6/6a and the magnetic circuit 2b can be reduced compared to in the speaker 1/1a, which contributes to further reducing the profile dimension.

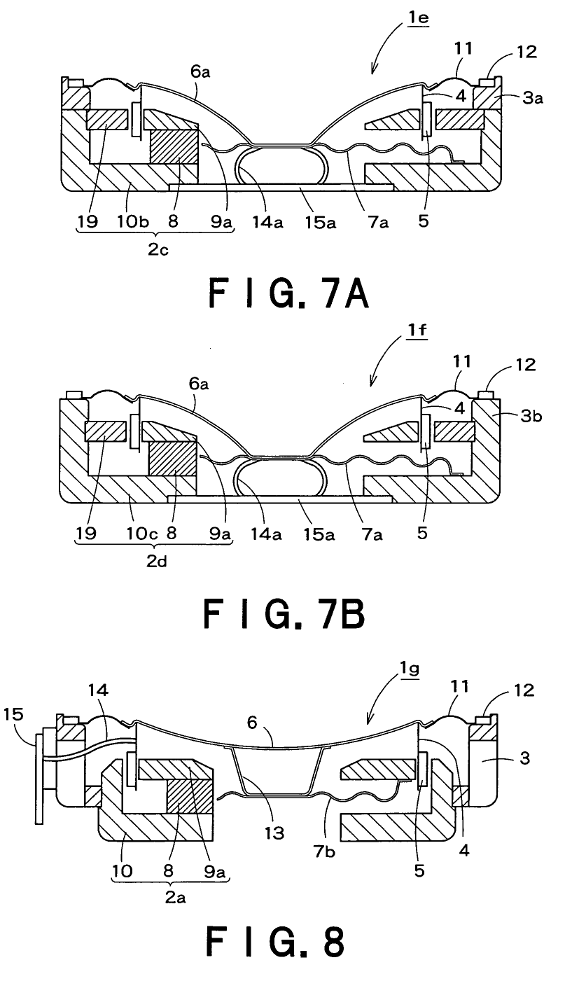

A fifth embodiment of the present invention will be described with reference to FIGS. 7A and 7B showing respective variations of the embodiment. Referring to FIGS. 7A and 7B, speakers 1e and 1f according to the respective variations of the fifth embodiment differ from the speakers 1 to 1d according to the preceding embodiments significantly in terms of magnetic circuit and frame structure. In explaining the examples of FIGS. 7A and 7B, any component parts corresponding to those in the relevant figures are denoted by the same reference numerals, and description will be focused on the difference.

Referring to FIG. 7A, the speaker 1e includes a magnetic circuit 2c which is composed of: a magnet unit made up of a plurality of magnet pieces 8; a pole piece 9a; a yoke 10b which is configured to extend radially outwardly from the rear of the magnet unit (the magnet pieces 8) so as to have its outer diameter defining the outer diameter of the speaker 1e and then to extend forwardly forming a circular-hollow cylinder portion; and an upper yoke 19 which is not provided in the preceding embodiments. The upper yoke 19 is attached to the inner circumference face of the cylinder portion of the yoke 10b such that a magnetic gap is formed between the inner circumferential face of the upper yoke 19 and the outer circumferential face of the pole piece 9a. A frame 3a formed in a ring shape and having an outer diameter equal to that of the yoke 10b is attached to the front of the cylinder portion of the yoke 10b. In FIG. 7A, the upper yoke 19 is disposed flush with the front of the cylinder portion of the frame 3a, and the frame 3a is disposed in contact with both the yoke 10b and the upper yoke 19, but the present invention is not limited to such a structure, and depending on the diameter of the frame 3a, or on the attachment position of the upper yoke 19, the frame 3a may alternatively be disposed in contact either with the yoke 10b only or with the upper yoke 19 only. And, a spider 7a of the speaker 1e, thanks to the fully radially extended diameter of the yoke 10b, can have longer legs than the spider 7 incorporated in the preceding embodiments, and is attached to the front of the bottom portion of the yoke 10b with the distal end tips of the legs located rearward of the upper yoke 19.

Referring to FIG. 7B, the speaker 1f is structured very similarly to the speaker 1e of FIG. 7A. The speaker 1f includes a magnetic circuit 2d which is composed of: a magnet unit made up of a plurality of magnet pieces 8; a pole piece 9a; a yoke 10c, and an upper yoke 19, wherein the yoke 10c is structured similarly to the yoke 10b but differs therefrom in that its cylinder portion extends further forwardly thereby integrally forming a frame 3b corresponding to the frame 3a shown in FIG. 7A, thus eliminating a discrete frame component. The upper yoke 19 is attached to the inner circumference of the cylinder portion of the yoke 10c such that a magnetic gap is formed between the inner circumferential face of the upper yoke 19 and the outer circumferential face of the pole piece 9a. And, a spider 7a with its legs extended compared to the spider 7 previously described is attached to the front of the bottom portion of the yoke 10c with the distal end tips of the legs located rearward of the upper yoke 19.

In the speaker 1e/1f of FIG. 7A/7B structured as described above, the spider 7a can have longer legs to define a greater diametrical dimension d2 than the spider 7 employed in the preceding embodiments, and consequently the resonance frequency can be set still lower.

A sixth embodiment of the present invention will be described with reference to FIG. 8. Referring to FIG. 8, a speaker 1g according to the sixth embodiment is basically the same as the speaker 1 of FIG. 1B according to the first embodiment except attachment structure of a spider. In explaining the example of FIG. 8, any component parts corresponding to those in FIG. 1B are denoted by the same reference numerals, and description-will be focused on the difference.

The speaker 1g of FIG. 8 includes a spider 7b which has its leg distal end tips attached to the rear of a pole piece 9a, rather than to the front of the bottom portion of a yoke 10 as in the speaker 1 of FIG. 1B.

The speaker 1g thus structured provides the same effects and advantages as the speaker 1 according to the first embodiment.

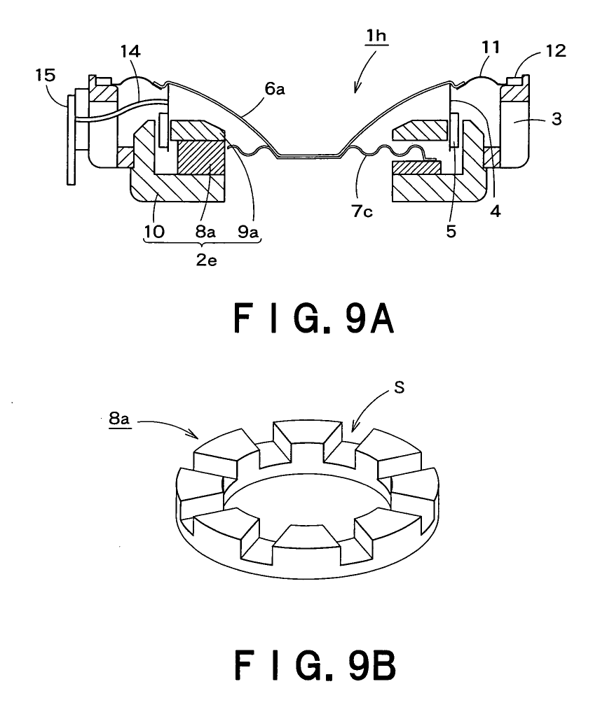

A seventh embodiment of the present invention will be described with reference to FIGS. 9A and 9B. Referring to FIGS. 9A and 9B, a speaker 1h according to the seventh embodiment differs from the speaker 1b of FIG. 2 according to the second embodiment in magnet unit composition and attachment structure of a spider, and description will be made mainly on the differences.

The speaker 1h of FIG. 9A includes a magnet unit composed of a ring magnet 8a having a plurality (eight in FIG. 9B) of grooves S on the front face as shown in FIG. 9B. In the speaker 1h, a spider 7c has its leg distal end tips attached in respective grooves S. Otherwise, the speaker 1h is structured substantially the same as the speaker 1a according to the second embodiment.

In the speaker oh structured as described above, since the magnet unit (the ring magnet 8a) is of a one-piece structure, the assembly work can be simplified.

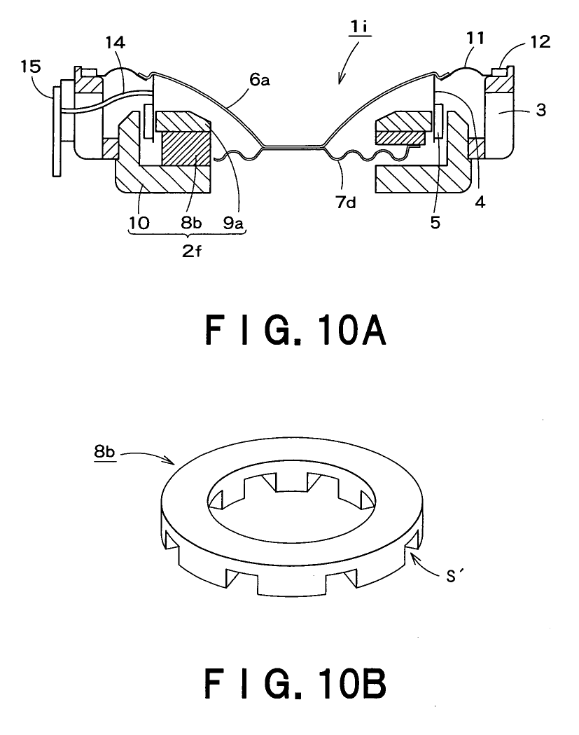

An eighth embodiment of the present invention will be described with reference to FIG. 10A and 10B. Referring to FIGS. 10A and 10B, a speaker 1i according to the eighth embodiment differs from the speaker 1h according to the seventh embodiment in magnet unit composition and attachment structure of a spider.

The speaker 1i of FIG. 10A includes a magnet unit composed of a ring magnet 8b having a plurality (eight in FIG. 10B) of grooves S′ on the rear face a shown in FIG. 10B, rather than on the rear face. In the speaker 1i, a spider 7d has its leg distal end tips attached in respective grooves S′. Otherwise, the speaker 1i is structured the same as the speaker 1h according to the seventh embodiment. While the distal end tips of the legs of the spider 7d are attached in the grooves S′ in FIG. 10A, the present invention is not limited to such a disposition, and alternatively the distal end tips of the legs of the spider 7d may possibly pass beyond the outer circumference of the ring magnet 8b and be attached to the front face of the bottom of the yoke 10.

In the speaker 1i structured as described above, since the magnet unit (the ring magnet 8b) is of a one-piece structure, the assembly work can be simplified.

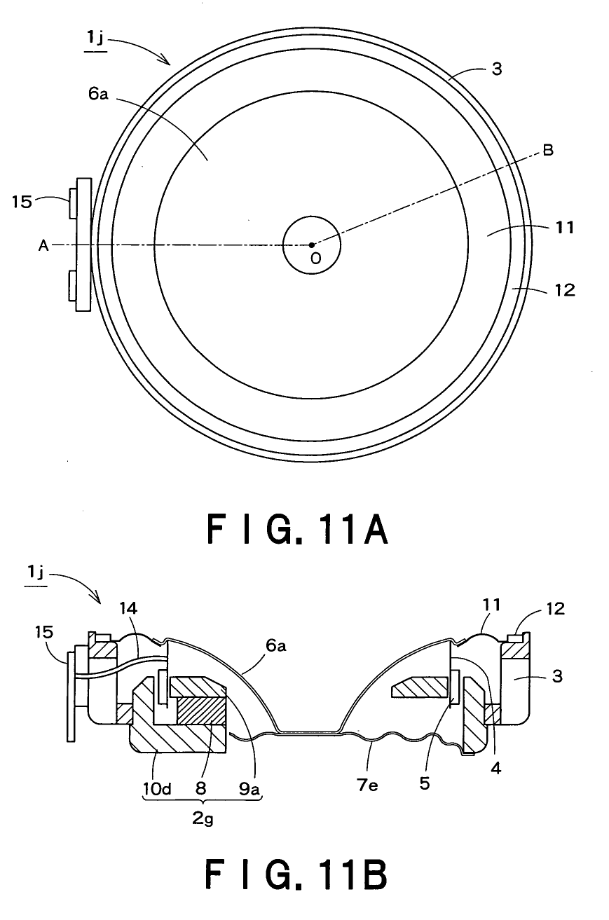

A ninth embodiment of the present invention will be described with reference to FIGS. 11A to 11C, by comparing with the speaker 1a of FIG. 2 according to the second embodiment. Referring to FIGS. 11B and 11C, a speaker 1j according to the ninth embodiment differs from the speaker 1a in spider and yoke shape.

Referring to FIG. 11B, the speaker 1j includes a magnetic circuit 2g, which is composed of a magnet unit made up of a plurality of magnet pieces 8, a pole piece 9a, and a yoke 10d. The yoke 10d is shaped like a pot and includes a circular-hollow cylinder portion and a bottom portion which has a center opening and a plurality (eight in FIG. 11C) of recesses Y radially outwardly extending from the opening and passing between two adjacent magnet pieces 8 so as to reach the cylinder portion as shown in FIG. 1C. In the speaker 1j, a spider 7e includes legs which, thanks to the aforementioned recesses Y, have their distal end tips adapted to be attached to the rear of the cylinder portion of the yoke 10d, thus enabling the leg length or the diametrical dimension d2 of the spider 7e to be greater than that of the spider 7 of the speaker 1a.

In the speaker 1j structured as described above, since the diametrical dimension d2 of the spider 7e can be set greater than that of the spider 7 of the speaker 1a, the resonance frequency can be set still lower.

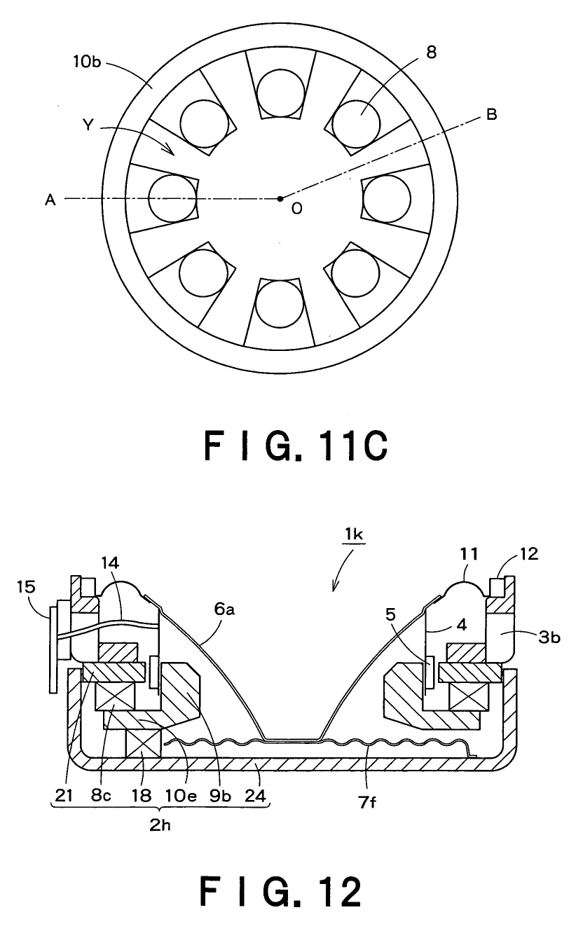

A tenth embodiment of the present invention will be described with reference to FIG. 12. Referring to FIG. 12, a speaker 1k according to the tenth embodiment differs from any of the speakers 1 to 1j according to the preceding embodiments in terms of magnetic circuit type such that the speaker 1k incorporates a magnetic circuit of an outer magnet type while the speakers 1 to 1j include a magnetic circuit of an inner magnet type.

The speaker 1k of FIG. 12 includes a magnetic circuit 2h which is of an outer magnet type as mentioned above, and which includes: a magnet unit composed of a ring magnet 8c; a top plate 21 disposed at the front of the magnet unit (the ring magnet 8c); a yoke 10e disposed at the rear of the magnet unit (the ring magnet 8c); a pole piece 9b integrally connected to the inner circumference of the yoke 10e; a repulsion magnet unit made up of a plurality of repulsion magnet pieces 18 and disposed at the rear of the yoke 23; and a yoke cover 24 formed in a pot shape and connected to the rears of the repulsion magnet pieces 18. A magnetic gap is formed between the inner circumferential face of the top plate 21 and the outer circumferential face of the pole piece 9b, and a voice coil 5 wound around a bobbin 4 is disposed in the magnetic gap so as to be movable back and forth.

The repulsion magnet unit is composed of a one-piece member, typically a plain ring magnet, but may alternatively be made up of a plurality of magnet pieces like the magnet pieces 8 which make up the magnet unit in the preceding embodiments.

The repulsion magnet pieces 18 are discrete from each other, arranged equiangularly in a circular line, and thus make up a repulsion magnet unit in FIG. 12, but the repulsion magnet unit is by no means limited to such a magnet arrangement and may alternatively be composed of a one-piece ring magnet having grooves like, for example, the ring magnet 8a of FIG. 9B, and the ring magnet 8b of FIG. 10B though not shown.

The speaker 1k further includes a diaphragm 6a which has its outer circumference connected via a surround 11 to a frame 3b attached to the forefront of the top plate 21 and which has its flat center area attached to the front of the center area of a spider 7f. The spider 7f has legs which each pass between two adjacent repulsion magnet pieces 18 and which have their distal end tips attached to the front of the bottom portion of the yoke cover 24.

The speaker 1k structured as described above can have a lower profile than a conventional speaker having an outer magnetic circuit, and at the same time is adapted to utilize spaces around the repulsion magnet pieces 18 thereby extending the leg length or the diametrical dimension d2 of the spider 7f and thus enabling the resonance frequency to be set lower.

The distal end tips of the legs of the spider 7f do not have to be attached to the front of the bottom portion of the yoke cover 24 as described above but may alternatively be attached to, for example, the rear of the yoke 10e, or may have an attachment arrangement which is used in the above-described speaker 1j of FIG. 11B according to the ninth embodiment when the yoke cover 24 is configured to have a center opening and recesses (refer to FIG. 11C), in which case a terminal plate 15, like the terminal plate 15 used in some of the preceding embodiments, may be disposed at the rear of the bottom portion of the yoke cover 24.

While the present invention has been illustrated and explained with respect to specific embodiments thereof, it is to be understood that the present invention is by no means limited thereto but encompasses all changes and modifications that will become possible within the scope of the appended claims.

For example, the present invention is not limited in diaphragm structure to the embodiments described above, specifically, to “inverted-dome” and “cone” shape, but may alternatively incorporate a “flat” or “forward domed” diaphragm.

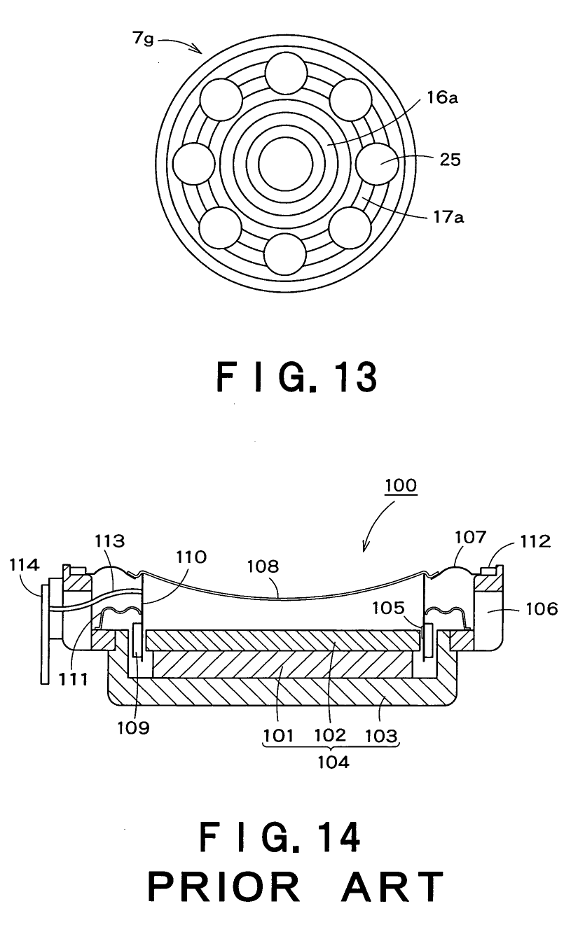

Also, the present invention is not limited in spider shape to the above embodiments, and may alternatively incorporate, for example, a spider 7g as shown in FIG. 13 which includes a center portion 16a corresponding to the above-described main body 16, and an outer portion 17a integrally extending radially outwardly from the circumference of the center portion 16a and structurally equivalent to the legs 17, and which has holes 25 located and shaped corresponding to the magnet pieces 8 or the repulsion magnet pieces 18.

Further, the distal end tips of the legs of the spider 7b are attached to the rear of the pole piece 9a in the sixth embodiment, and such a disposition of the distal end tips of spider legs may be employed in the other embodiments where applicable.

What is claimed is:

1. A speaker comprising:
a magnetic circuit having a ring shape and including: a magnet unit which has a ring structure having a plurality of empty portions arranged equiangularly; a pole piece; and a yoke which has a ring shape with a center opening and is disposed at a rear of the magnet unit;
a voice coil bobbin;
a voice coil wound around the voice coil bobbin, suspended in a gap of the magnetic circuit, and having lead-out wires led out therefrom;
a diaphragm to move back and forth together with the voice coil;
a frame to which an outer circumference of the diaphragm is connected via a suspension; and
a spider to support a center area of the diaphragm, wherein the spider has a main body and a plurality of legs extending radially outwardly from the main body, and distal end tips of the legs pass beyond an inner diameter of the ring structure of the magnet unit.

2. A speaker according to claim 1, wherein the ring structure of the magnet unit comprises a plurality of magnet pieces arranged equiangularly along a circular line, spaces are formed each between two adjacent magnet pieces and function as the empty portions of the ring structure, and the distal end tips of the legs of the spider pass in the spaces and are attached to the yoke.

3. A speaker according to claim 1, wherein the yoke has a plurality of recesses extending radially outwardly from the center opening thereof, the legs of the spider are disposed respectively in the recesses, and the distal end tips of the legs are attached to a rear of the yoke.

4. A speaker according to claim 1, further comprising tinsel wires connected to the lead-out wires and a terminal plate disposed at an outer circumference of either the frame or the yoke, wherein the lead-out wires are located outside the voice coil bobbin, disposed between the diaphragm and the magnetic circuit and are connected via the tinsel wires to the terminal plate.

5. A speaker according to claim 1, further comprising tinsel wires connected to the lead-out wires and a terminal plate disposed at the center opening of the yoke, wherein the lead-out wires are located inside the voice coil bobbin, disposed on a rear of the diaphragm and are connected via the tinsel wires to the terminal plate.

6. A speaker according to claim 1, wherein the ring structure of the magnet unit comprises a one-piece ring magnet which has a plurality of grooves arranged equiangularly on a front thereof, the empty portions of the ring structure has the grooves, and the distal end tips of the legs of the spider are attached respectively in the grooves.

7. A speaker according to claim 1, wherein the ring structure of the magnet unit comprises a one-piece ring magnet which has a plurality of grooves arranged equiangularly on a rear thereof, the grooves function as the empty portions of the ring structure, and the distal end tips of the legs of the spider are attached respectively in the grooves.

8. A speaker according to claim 1, wherein the magnetic circuit is of an inner magnet type.

9. A speaker according to claim 8, wherein the pole piece is disposed at a front of the magnet unit, the yoke has a pot shape having a circular-hollow cylinder portion, the magnetic gap of the magnetic circuit is formed between an inner circumferential face of the yoke and an outer circumferential face of the pole piece, and the frame is connected to the yoke.

10. A speaker according to claim 8, further comprising an upper yoke to make up a part of the magnetic circuit, wherein the pole piece is disposed at a front of the magnet unit, the yoke has a pot shape having a circular-hollow cylinder portion, the upper yoke is attached to an inner circumferential face of the cylinder portion of the yoke, the magnetic gap of the magnetic circuit is formed between an inner circumferential face of the yoke and an outer circumferential face of the pole piece, and the frame is connected to at least one of a front of the cylinder portion of the yoke and a front of the upper yoke.

11. A speaker according to claim 8, further comprising an upper yoke to make up a part of the magnetic circuit, wherein the pole piece is disposed at a front of the magnet unit, the yoke has a pot shape having a circular-hollow cylinder portion, the upper yoke is attached to an inner circumferential face of the cylinder portion of the yoke, the magnetic gap of the magnetic circuit is formed between an inner circumferential face of the yoke and an outer circumferential face of the pole piece, and the frame is structured to extend integrally from a front of the cylinder portion of the yoke.

12. A speaker according to claim 1, wherein the distal end tips of the legs of the spider are attached to a rear of the pole piece.

13. A speaker according to claim 1, wherein a rear of a center area of the diaphragm is connected directly to a front of a center area of the spider.

14. A speaker according to claim 1, further comprising a coupler, wherein a rear of a center area of the diaphragm is connected to a front of a center area of the spider via the coupler.

15. A speaker according to claim 1, wherein the diaphragm comprises a center diaphragm and an outer diaphragm which has an inner circumference thereof connected to an outer circumference of the center diaphragm and which has an outer circumference thereof connected via the suspension to either of the frame or a frame equivalent segment.

16. A speaker comprising:
a magnetic circuit of an outer magnet type, the magnetic circuit having a ring shape and including: a magnet unit; a pole piece; a yoke which has a ring shape with a center opening, is disposed at a rear of the magnet unit, and has the pole piece integrally connected thereto; a repulsion magnet unit disposed at a rear of the yoke and having a ring structure having a plurality of empty portions arranged equiangularly; a top plate disposed at a front of the magnet unit, wherein a magnetic gap of the magnetic circuit is formed between an inner circumferential face of the top plate and an outer circumferential face of the pole piece; and a yoke cover disposed at a rear of the repulsion magnet unit;
a voice coil bobbin;
a voice coil wound around the voice coil bobbin, suspended in the gap of the magnetic circuit, and having lead-out wires led out therefrom;
a diaphragm to move back and forth together with the voice coil;
a frame to which an outer circumference of the diaphragm is-connected via a suspension; and
a spider to support a center area of the diaphragm, wherein the spider has a main body and a plurality of legs extending radially outwardly from the main body, and distal end tips of the legs of the spider pass beyond an inner diameter of the ring structure of the repulsion magnet unit.

17. A speaker according to claim 16, wherein the distal end tips of the legs of the spider are attached to either of a front of the yoke cover or a rear of the yoke.

18. A speaker according to claim 16, wherein the ring structure of the repulsion magnet unit comprises a plurality of repulsion magnet pieces arranged equiangularly in a circular line, spaces are formed each between two adjacent repulsion magnet pieces and function as the empty portions of the ring structure, and the legs of the spider are disposed in the spaces.

19. A speaker according to claim 16, wherein the ring structure of the repulsion magnet unit comprises a one-piece ring magnet which has a plurality of grooves arranged equiangularly on a front thereof, the grooves function as the empty portions of the ring structure, and the legs of the spider are disposed in respective grooves.

20. A speaker according to claim 16, wherein the ring structure of the repulsion magnet unit comprises a one-piece ring magnet which has a plurality of grooves arranged equiangularly on a rear thereof, the grooves function as the empty portions of the ring structure, and the legs of the spider are disposed in respective grooves.
